(19) United States
(12) Patent Application Publication
(10) Pub. No.: US 2007/0271356 A1
(43) Pub. Date: Nov. 22, 2007

(54) WEB-BASED EQUIPMENT FIRMWARE CONTROL SYSTEM AND METHOD THEREFOR

(75) Inventors: Fan-Sheng Lin, Taipei City (TW); Chin-Wei Lin, Taipei City (TW)

Correspondence Address: WORKMAN NYDEGGER, 60 EAST SOUTH TEMPLE, 1000 EAGLE GATE TOWER, SALT LAKE CITY, UT, 84111, US

(73) Assignee: ETROVISION TECHNOLOGY, Taipei City (TW)

(21) Appl. No.: 11/534,835

(22) Filed: Sep. 25, 2006

(30) Foreign Application Priority Data
May 17, 2006 (TW) 095117545

(51) Int. Cl. G06F 15/177; G06F 15/173

(52) U.S. Cl. 709/220; 709/223

(57) ABSTRACT

A web-based equipment firmware control system and method are provided, wherein a device is electrically connected to a computer executable platform through a communication interface, and a control webpage capable of controlling the equipment firmware is generated in a file system of the computer executable platform through the communication between the respective storage interfaces, provided in the device and the computer executable platform. Hereby, the control webpage is displayed to facilitate the operation of the user. As such, the user may issue the control instruction through the control webpage. Thus, the control instruction is sent to the equipment firmware for processing through the communication between the respective control interfaces. Then a return message indicating the processing result is transmitted back to the control webpage in a similar maimer through the respective control interfaces.

### CROSS-REFERENCE TO RELATED APPLICATIONS

This non-provisional application claims priority under 35 U.S.C. §119(a) on Patent Application No(s). 095117545 filed in Taiwan, R.O.C. on May 17, 2006, the entire contents of which are hereby incorporated by reference.

### BACKGROUND

1. Field of Invention

The invention relates to an equipment firmware control system and method, and in particular to a control system and method that can be used to connect a device electrically to a computer executable platform through a communication interface and control the equipment firmware through a control webpage.

2. Related Art

Nowadays, most of the equipment products available on the market are capable of controlling the firmware contained therein. From the standpoint of the network hardware (such as a router and a broadband sharing device), the control items include: network configuration setting, device condition monitoring, and firmware updating, that are all realized through a network interface.

As shown in FIG. 1, it is a schematic diagram of a conventional equipment firmware control system implemented through a network interface. In FIG. 1, the computer executable platform 40 operated by a user 30 is connected to a device 10 which is waiting for receiving a control to a firmware through a network 20 (for example, Ethernet) by making use of the respective network interfaces. In order to fully realize communication, the computer executable platform 40 and the device 10 must both have the network addresses in compliance with the related network communication protocol. As such, when the user 30 intends to control the firmware (not shown) of the device 10, he/she has to verify first if both the device 10 and the computer executable platform 40 are functioning normally in their respective networks, then the user 30 may utilize application programs (not shown) provided in the computer executable platform 40, to specify the network address of the device 10 and/or even some other network parameters, so that the computer executable platform 40 and device 10 may establish a communication channel required through the network. Thus the user 30 may control the firmware of the device 10 through the user interface provided by the application programs.

However, such parameter preset operations are rather complicated and difficult, so that it is not easy for the user 30 to master. In addition, quite often, the utilization of network interface in establishing communication channels between the computer executable platform 40 and the device 10 is subjected to the restriction of the network 20. As such, on the whole, the utilization of the network interface to realize the equipment firmware control is rather difficult and unreliable.

Moreover, presently, in the overall application framework utilized in implementing the equipment firmware control through the network interface, the design of the user interface done by most of the application programs is web-based. Namely, the design and development of the application programs are mainly web-based, due to the popularization and rapid development of the World Wide Web (WWW), so that the user may directly activate the application programs and its user interface by means of a web browser, thus providing a more friendly and straight forward user operation environment.

In order to realize such web-based application programs, a web browser built in computer executable platform 41 and a web server built in device 11 must be provided as shown in FIG. 2, so that a control webpage 50 from a web server can be displayed. Presently, the web browser built in computer executable platform 41 is quite common, so that the user 30 may use it as required without any difficulty. However, for the implementation of the web server built in device 11, namely, in case the web server is to be provided and built in each of the devices, then the chance of its realization would be slim due to the fact that the incurring software/hardware design and the overall installation/implementation costs will be raised significantly. Thus, the complexity of the overall application framework in implementing the equipment firmware control through the network interface may further impede and restrict the development and popularization of the related equipment firmware control mechanism.

Therefore, the above-mentioned problems and restrictions of the prior art must be overcome, thus being able to provide a more simplified, stable, and straightforward equipment firmware control mechanism, as such raising the operation efficiency and reducing the cost of the equipment firmware control system.

### SUMMARY OF THE INVENTION

It is an object of the invention is to provide a web-based equipment firmware control system and method for solving and overcoming the problems of complicated operation and unstable network performance of the network interface.

It is another object of the invention is to provide a web-based equipment firmware control system and method for overcoming the obstacle that users have to learn how to operate the new interface, and the threshold problem that the system developer has to be able to migrate the system. Especially, the webpage browser has gradually become the standard built-in application programs in most operation system platforms, such as the Macintosh operation system platform and the Windows operation system platform. As such, the process of cross platform control of the equipment firmware through a web-based control webpage has thus become easy and simple.

Accordingly, to achieve the objects, the present invention discloses a web-based equipment firmware control method, upon connecting the device electrically to the computer executable platform, further including the following steps:

(a) activating the device to read file elements from the equipment firmware and driving the computer executable platform into proceeding by receiving the file elements through a communication interface; (b) generating a control webpage in the file system of computer executable platform by making use of the file elements to control the equipment firmware; (c) receiving the control instructions sent by the control webpage, and transmitting them to the equipment firmware for further processing through a communication interface between the computer executable platform and the device, and (d) transmitting back to the control webpage the return message through the communication interface, that is generated as based on the result of processing the control instruction.

In addition, to achieve the above-mentioned objects, the present invention also discloses a web-based equipment firmware control system, including a device and a computer executable platform, which will be described more detailed as follows.

(a) The device, provided with a second communication interface, further includes equipment firmware and a second driver interface, used to activate the device to read file elements from equipment firmware upon being electrically connected to the device.

(b) The computer executable platform, provided with a first communication interface and electrically connected to a second communication interface, further includes a file system and a first driver interface, used to receive the file elements from the second driver interface, and generate the control webpage in the file system to control the equipment firmware.

In the above-mentioned structure, the communication channel between the first driver interface and the second driver interface may be used by the latter to receive the control instructions from the control webpage and transmit them to the equipment firmware for processing. Then, such a communication channel is utilized by the second driver interface to transmit a return message corresponding to the control instruction, processed by the equipment firmware, back to the control webpage.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow for illustration only, and thus is not limitative of the invention, wherein:

FIG. 1 is a schematic diagram of a equipment firmware control system, implemented through a network interface according to the prior art;

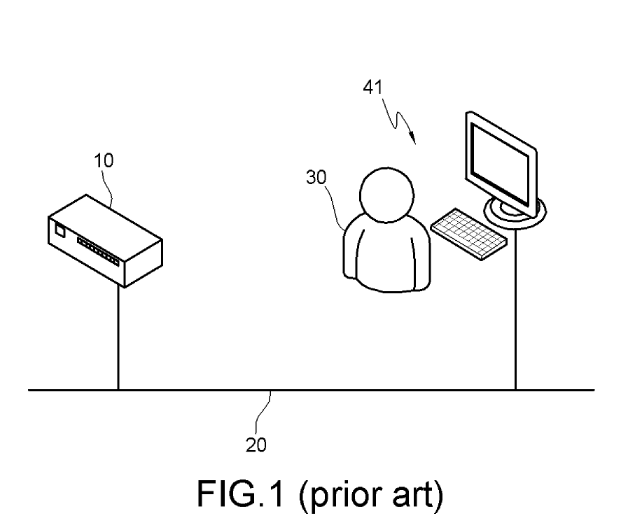

FIG. 2 is a schematic diagram of a web-based equipment firmware control system, implemented through a network interface according to the prior art;

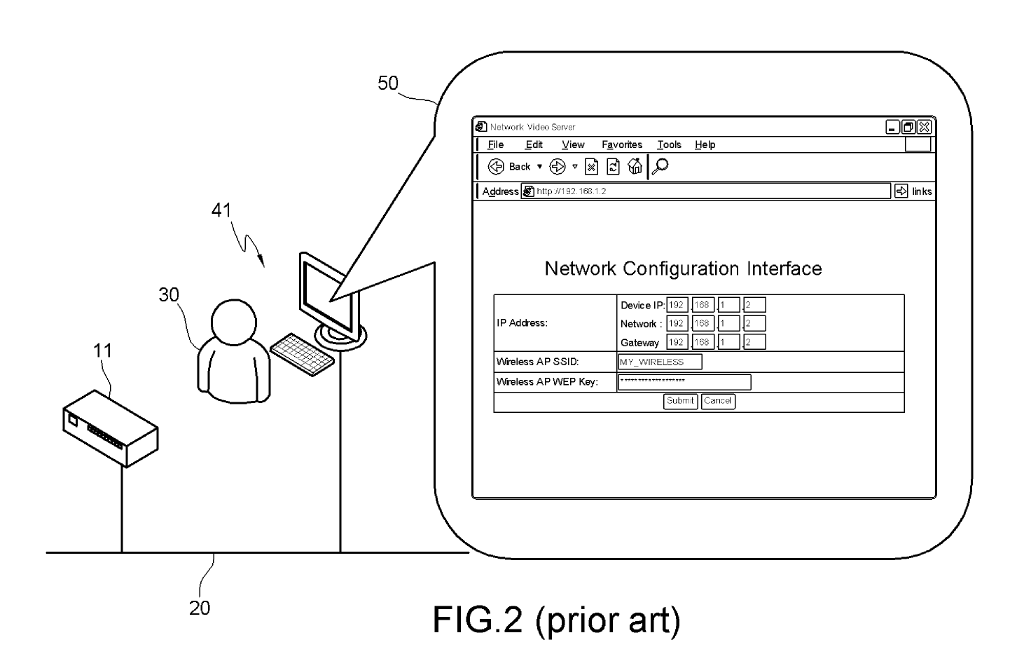

FIG. 3 is a schematic diagram of the web-based equipment firmware control system, implemented through a communication interface according to an embodiment of the invention;

FIG. 4 is a schematic diagram of the software interface of the web-based equipment firmware control system, implemented through a communication interface according to an embodiment of the invention;

FIG. 5 is a flowchart of the steps of the web-based equipment firmware control method, implemented through a communication interface according to an embodiment of the invention; and

FIG. 6 is a schematic diagram of a web-based equipment firmware control system, implemented through a communication interface according to an embodiment of the invention.

### DETAILED DESCRIPTION OF THE INVENTION

The purpose, construction, features, and functions of the invention can be appreciated and understood more thoroughly through the following detailed description with reference to the attached drawings.

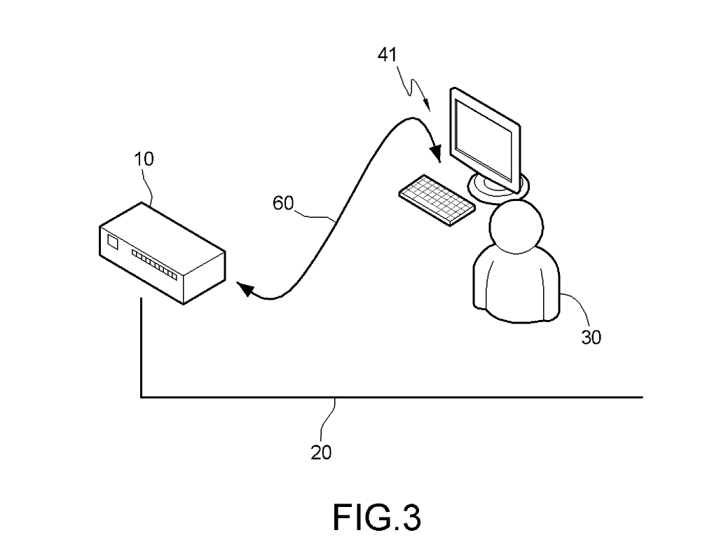

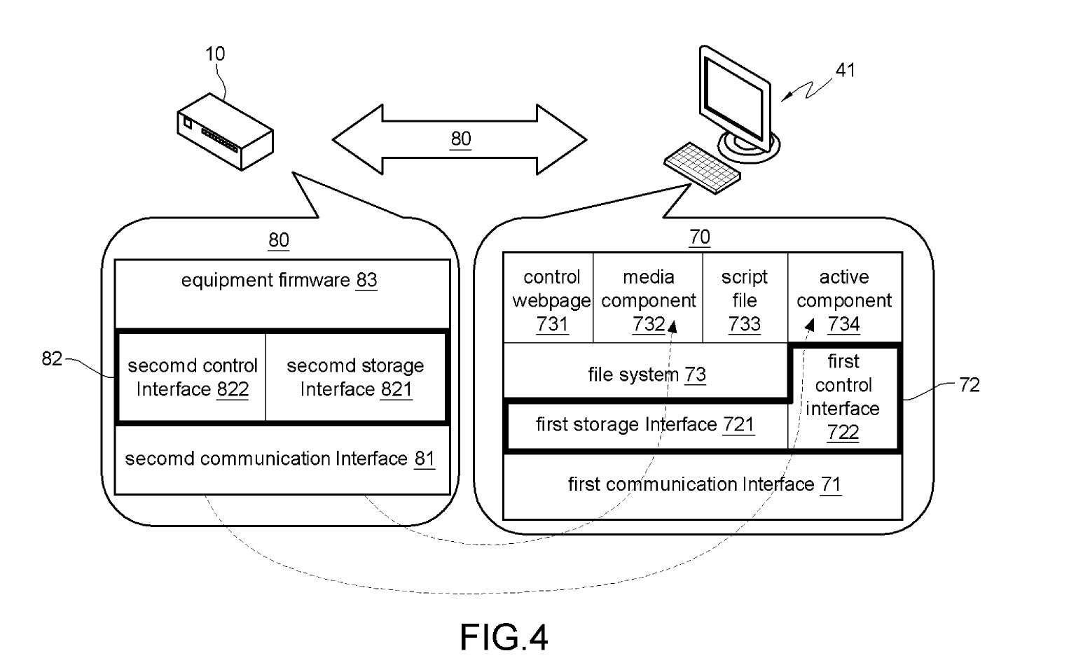

In order to solve the problems of the prior art, the present invention discloses a web-based equipment firmware control system and method. Please refer to FIGS. 3 and 4. FIG. 3 is a schematic diagram of the web-based equipment firmware control system implemented through a communication interface according to an embodiment of the present invention. FIG. 4 is a schematic diagram of the software interface of the web-based equipment firmware control system implemented through a communication interface according to an embodiment of the invention. As shown in FIGS. 3 and 4, the communication interface (for example: USB) 60 instead of a network interface provided in a network 20 (for example, Ethernet) is utilized to connect the device 10 electrically to a web browser built in computer executable platform 41, so as to exercise the control required for a equipment firmware 83 in the device 10.

In the above description, the device 10 of the present invention is defined as hardware equipment having the capability of executing a specific function. For instance, the ordinary network equipment in a network 20 environment, such as, a router, a broadband sharing device, etc., each having the capability of route planning and broadband sharing in a network 20 environment. Usually, the device 10 is provided with the firmware 83, capable of executing a specific function. In addition, a web browser built in computer executable platform 41 is defined as a basic man-machine interface (namely interface used for input/output and display) and a webpage browser, such as an Internet Explorer webpage browser, a Netscape webpage browser, that can be used to browse and view the contents displayed as a webpage. The example of such a computer executable platform may include: a personal computer, a notebook computer, a palm computer, etc. As to the connection between a device and a web browser built in computer executable platform 41, the network hardware equipment is likewise taken as an example, thus it can be connected through a network 20 or through another communication interface 60.

To be more specific, the essence of the technical contents of the invention is to provide a system and method for controlling the firmware 83 while connecting a device electrically to the computer executable platform through the hardware type communication interface 60 (like USB). In addition, the IEEE1394 serial bus communication interface may be utilized as another embodiment of the invention, and will not be repeated here for brevity's sake. Consequently, the USB serial bus is taken as an example while explaining the embodiments of the invention, and will be described in detail as follows.

Then, please refer to FIG. 4 of a schematic diagram of the software interface of the web-based equipment firmware control system implemented through a communication interface according to an embodiment of the invention. As shown in FIG. 4, the device 10 is electrically connected to a web browser built in computer executable platform 41 through the communication interface 60. The essence of the operation of the control system and method of the invention is explained and exemplified through a first software interface 70 of the web browser built in computer executable platform 41 and a second software interface 80 in the device 10.

Firstly, for the normal and proper application of the invention, a file system 73 has to be provided in the first software interface 70, and an equipment firmware 83, capable of executing specific functions, has to be provided in the second software interface 80.

Moreover, in the interaction between the device 10 and the web browser built in computer executable platform 41, the functionally corresponding first communication interface 71 and the second communication interface 81 must be provided respectively in the first software interface 70 and the second software interface 80, that are utilized to perform signal communications when the device 10 and the web browser built in computer executable platform 41 are electrically connected through the communication interface 60. Furthermore, a first driver interface 72 and a second driver interface 82 are provided in the first software interface 70 and the second software interface 80 respectively. As such, the two software interfaces also respectively include a functionally corresponding first storage interface 721 and a second storage interface 821, and a first control interface 722 and a second control interface 822. Thus, the first storage interface 721 and the second storage interface 821 are driven to read the predetermined file elements from the equipment firmware 83, upon effecting the above-mentioned electrical connection, and then transmit them into the file system 73 of the web browser built in computer executable platform 41 as such creating and displaying a control webpage, in a webpage browser, in an automatic activation or user activation manner.

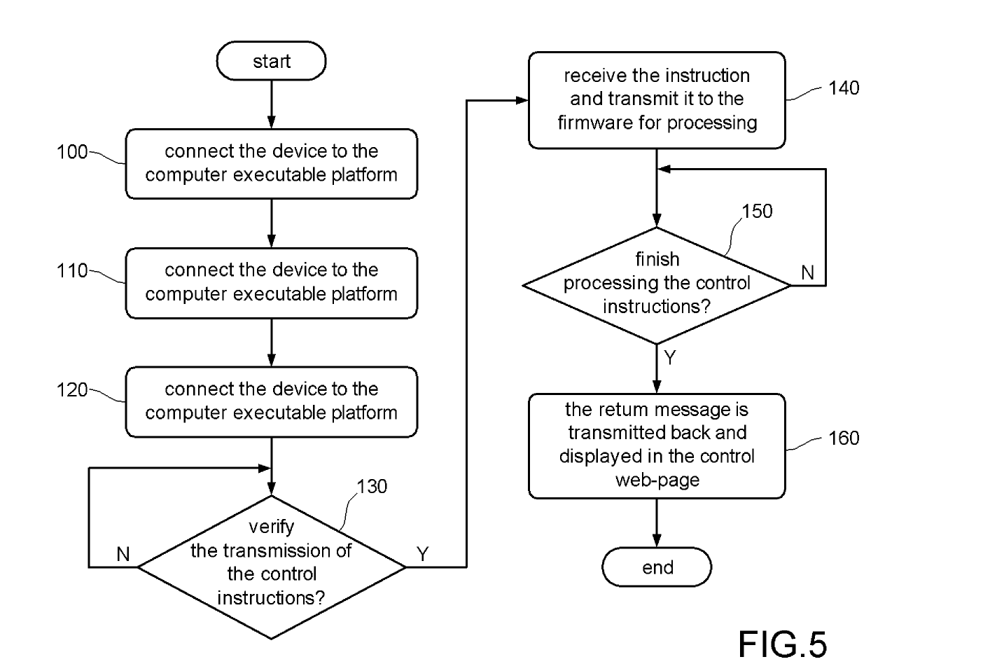

Subsequently, please refer to FIG. 5 of a flowchart of the steps of the web-based equipment firmware control method, implemented through a communication interface according to an embodiment of the present invention. As shown in FIG. 5, firstly, the device 10 is electrically connected to the web browser built in computer executable platform 41 (step 100) through the communication interface 60. Then, upon successful completion of the electrical connection, a virtual disk directory is created in the file system 73 of the web browser built in computer executable platform 41 by the second storage interface 821 through the first storage interface 721.

Then, a set of file elements are fetched from the equipment firmware 83 by the driven second storage interface 821 of the device 10. Further, the set of file elements are transmitted to the file system 73 through the second communication interface 81, the first communication interface 71, and the first storage interface 721 (step 110). Subsequently, a control webpage is generated in the file system 73 for controlling the equipment firmware 83 in the previously created virtual disk directory by making use of the file elements (step 120).

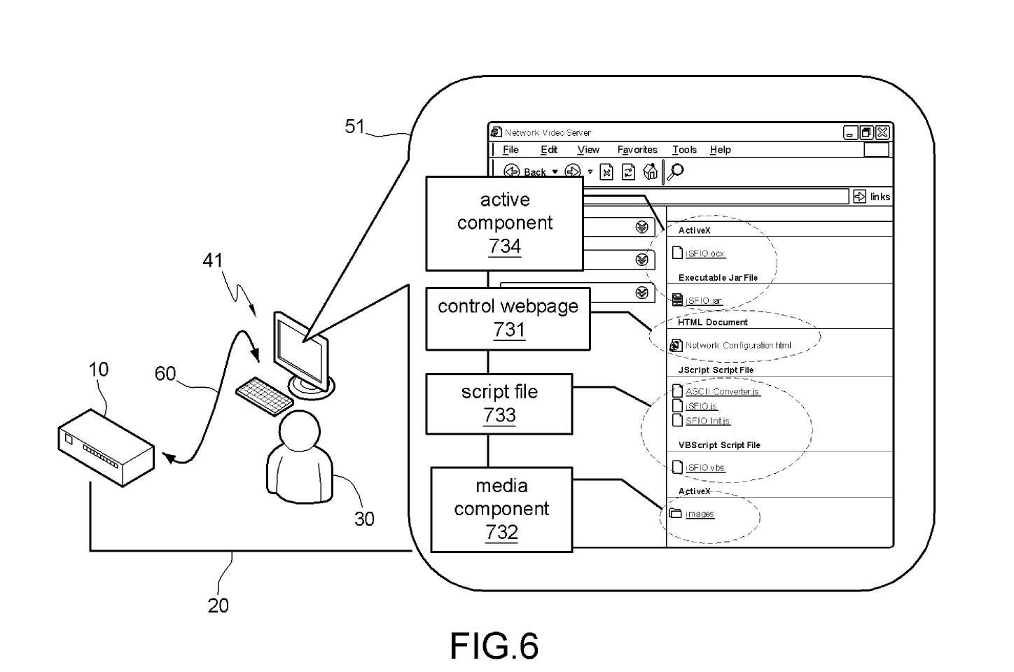

As shown in FIG. 6, the control webpage 51 directly generated by the file elements transferred from the equipment firmware 83, including the following file elements: a control webpage 731, written in a webpage language program, such as the HyperText Markup Language (HTML), and the Active Server Pages (ASP), and used to generate a control main body. Further, a media component 732 (for example: a graphic file) is used to generate visualized representation in the control webpage. Included as well is a script file 733, written in a Script Language Program (for example, JAVA Script, VB Script), and used to generate the scripts for controlling the firmware. Another file element is an active component 734 (for example: ActiveX, JAVA Applet), used to receive the control instruction, selected in the control webpage by the user 30, transmitted to the equipment firmware 83 for processing, and receiving the return message transmitted back from the equipment firmware 83 after processing.

Moreover, upon finishing creating the control webpage, activating a webpage browser in an automatic activation or user activation manner, thus generating and displaying the control webpage in the webpage browser, and waiting for the control operation from the user, concerning the equipment firmware 83. At this time, the user may proceed with the input or other operations (for example, selection) of the related control instruction, through an operation interface provided by the script file 733 of the control webpage. Upon verifying the transmission of the control instructions by the control webpage (step 130), the active component 734 is used to receive the control instruction and transmit it to the equipment firmware 83 for processing through the first control interface 722, the first communication interface 71, the second communication interface 81, and the second control interface 822 (step 140).

Furthermore, implementing the processing required by the equipment firmware 83 based on the received control instruction. In this case, the network hardware equipment is taken as an example, so that the processing may include: setting the network configuration recorded in the equipment firmware 83, and fetching the status monitoring information stored in the equipment firmware 83, or even proceeding with the update of the firmware. Upon finishing processing the control instructions by the equipment firmware 83 (step 150), basically the control of the equipment firmware 83 is realized and complete. However, in practice, the equipment firmware 83 may generate the corresponding return messages based on the results of control instruction processing, such as the network configuration setting, the status monitoring information, final processing result etc. Then this return message is transmitted back to the active component 734 and displayed in the control webpage through the second control interface 822, the second communication interface 81, the first communication interface 71, and the first control interface 722 (step 160).

As such, through the above-mentioned description and implementation, the webpage-based equipment firmware control system and method of the present invention can be realized. In particular, when the USB serial bus is utilized as a communication interface, the system and method of the present invention may be used to achieve the communication between the device 10 and the web browser built in computer executable platform 41 without having to acquire an additional power source. Further, the ordinary built-in standard storage interface (for example, the Mass Storage Class) of the communication interface 60 may be utilized for the purpose of straightforward driving, so that the communication between the device 10 and the web browser built in computer executable platform 41 may be realized without having to acquire additional non-standard driver programs. Moreover, the signal communications, using the non-network interface, could have the benefit of eliminating the problems of an unstable network and complicated preset operations. As such, the user 30 may realize the various controls of the equipment firmware 83 in a simple and straightforward operation environment, by using a friendly and familiar web-based user interface.

In addition, to the system developer, through the application of the system and method of the invention, the web-based application programs, using the network interface for communication, can be migrated easily and used in the environment of the web-based application programs, utilizing the communication interface for communication, thus saving the time and cost used for redeveloping the application programs of the system significantly.

Therefore, the computer executable platform of the present invention can be utilized to control the equipment firmware contained in the device, as such solving and overcoming the problem of complicated operation and unstable network performance of the network interface, thus achieving the purpose of simple design, easy connection, and effective and reliable control. Also the present invention can overcome the obstacle that users have to learn how to operate the new interface, and the threshold problem that the system developer has to migrate the system, so as to achieve simple design and straightforward operation.

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A web-based equipment firmware control method, wherein the equipment firmware is recorded in a device electrically connected to a computer executable platform, comprising the following steps:
(a) activating a second driver interface of the device to read a set of file elements from the equipment firmware upon being electrically connected and driving a first driver interface of the computer executable platform through a communication interface to receive the file elements;
(b) driving the first driver interface with the second driver interface and generating a control webpage in a file system by making use of the set of file elements to control the equipment firmware; and
(c) receiving a control instruction from the control webpage by the second driver interface through communicating with the first driver interface and transmitting the control instruction to the equipment firmware for further processing.

2. The web-based equipment firmware control method as claimed in claim 1, further comprising a step (d) of:
transmitting a return message generated by the equipment firmware based on the result of processing the control instruction to the control webpage through the second driver interface communicating with the first driver interface.

3. The web-based equipment firmware control method as claimed in claim 1, wherein the communication interface is a USB serial bus interface.

4. The web-based equipment firmware control method as claimed in claim 1, wherein the communication interface is an IEEE1394 serial bus interface.

5. The web-based equipment firmware control method as claimed in claim 1, wherein the step (a) and step (b) are performed by a first storage interface and a second storage interface included in the first driver interface and the second driver interface, respectively.

6. The web-based equipment firmware control method as claimed in claim 1, wherein the step (c) is performed by a first control interface and a second control interface included in the first driver interface and the second driver interface, respectively.

7. The web-based equipment firmware control method as claimed in claim 1, wherein the step (d) is performed by a first control interface and a second control interface included in the first driver interface and the second driver interface, respectively.

8. The web-based equipment firmware control method as claimed in claim 1, wherein the set of file elements is selected from a group consisting of a control webpage, a script file, a media component, and an active component.

9. The web-based equipment firmware control method as claimed in claim 1, wherein the control webpage displays and receives the control instructions through a webpage browser in the computer executable platform.

10. A web-based equipment firmware control system, comprising:
a device having a second communication interface comprising:
an equipment firmware; and
a second driver interface for activating and reading a set of file elements from the equipment firmware upon being electrically connected; and
a computer executable platform having a first communication interface and being electrically connected to the second communication interface, comprising:
a file system; and
a first driver interface for receiving the file elements from the second driver interface, and generating a control webpage in a file system by making use of the set of file elements to control the equipment firmware;
wherein the second driver interface is used to receive a control instruction from the control webpage, and transmit it to the equipment firmware for further processing through a communication with the first driver interface.

11. The web-based equipment firmware control system as claimed in claim 10, wherein the second driver interface is used to transmit a return message back to the control webpage, that is generated as based on processing the control instruction by the equipment firmware, through a communication channel between the first driver interface and the second driver interface.

12. The web-based equipment firmware control system as claimed in claim 10, wherein the first communication interface and the second communication interface are USB serial bus interfaces.

13. The web-based equipment firmware control system as claimed in claim 10, wherein the first communication interface and the second communication interface are IEEE1394 serial bus interfaces.

14. The web-based equipment firmware control system as claimed in claim 10, wherein the first driver interface and the second driver interface include respectively a first storage interface and a second storage interface, the second storage interface is used to read the set of file elements from the equipment firmware, drive the first storage interface to receive the set of file elements, and generate a control webpage in a file system by making use of the set of file elements to control the equipment firmware.

15. The web-based equipment firmware control system as claimed in claim 10, wherein the first driver interface and the second driver interface further comprise a first control interface and a second control interface, respectively, the second control interface is used to receive a control instruction from the control webpage through the first control interface, and transmit it to the equipment firmware for further processing.

16. The web-based equipment firmware control system as claimed in claim 11, wherein the first driver interface and the second driver interface further comprise a first control interface and a second control interface, respectively, the second control interface is used to transmit a return message based on the result of processing the control instruction by the equipment firmware to the control webpage, through the first control interface.

17. The web-based equipment firmware control system as claimed in claim 10, wherein the set of file elements is selected from a group consisting of a control webpage, a script file, a media component, and an active component.

18. The web-based equipment firmware control system as claimed in claim 10, wherein the control webpage displays and receives the control instructions through a webpage browser in the computer executable platform.
